(19) United States
(12) Patent Application Publication
(10) Pub. No.: US 2017/0100927 A1
(43) Pub. Date: Apr. 13, 2017

(54) MEDIA EMBOSSING METHOD AND SYSTEM FOR PRINTING DEVICES

(71) Applicant: Xerox Corporation, Norwalk, CT (US)

(72) Inventors: Timothy J. Clark, Weedsport, NY (US); Eliud Robles Flores, Webster, NY (US); Douglas E. Proctor, Rochester, NY (US); Timothy P. Foley, Marion, NY (US)

(73) Assignee: Xerox Corporation

(21) Appl. No.: 14/880,442

(22) Filed: Oct. 12, 2015

(51) Int. Cl. B41F 19/02

(52) U.S. Cl. CPC B41F 19/02

(57) ABSTRACT

Embossing methods and systems include a substrate (e.g., a sheet of paper or other material) delivered through a rendering device (e.g., a printer). An array of time-delayed pins can be driven into the substrate as the substrate travels through an in-line path provided by the rendering device to produce a latent embossed image composed of a combination of shapes depressed in the substrate. An ATA (Acoustic Transfer Assist) system can transfer an image to the substrate. The substrate with the latent embossed image is then transferred to the ATA system and the substrate is rendered with an embossed image based on the latent embossed image.

### TECHNICAL FIELD

Embodiments are generally related to rendering devices. Embodiments further relate to methods and systems for forming a raised image such as an embossed image on substrates such as paper sheets, textiles, metal, and other materials and products. Embodiments further relate to ATA (Acoustic Transfer Assist) technology.

### BACKGROUND

Embossing and debossing are processes for creating either raised or recessed relief images and designs on substrates, such as paper, metallic layers and foils, textiles, and other materials. An embossed pattern is raised against the background, while a debossed pattern is sunken into the surface of the material (but might protrude somewhat on the reverse, back side).

Emboss printing is widely used to make printed matters impressive. For example, firm's names and trademarks are often embossed on business cards, letter papers, and envelopes. Also, many invitation cards, Christmas cards, birthday cards, or the like are embossed with greeting words and other decorative images. Further, emboss printing is used to produce Braille, embossed graphs, or the like in publications for visually handicapped people to read by touching. Other materials and products, such as clothing, metal, and tiles can also be embossed.

Various methods of forming embossed images have been invented and used. FIG. 1 illustrates examples of prior art embossing plates, rolls, and embossed paper. For example, image of embossing rolls 12, 14 are shown in FIG. 1 along with an embossing plate 15 in the shape of a leaf and a subsequently embossed paper 16 having the embossed leaf image.

There currently does not exist, however, devices and systems that can quickly generate customizable documents, which combine embossing and printing. Typically, expensive die plates or rollers must be machine from blanks. The printer must be set, aligned, and registered with the artwork to be embossed. Changes to the dies or artwork are expensive and time consuming and trying to print an image on the embossed areas then proves to be a challenging task.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved embossing method and system for rendering devices such as printers.

It is another aspect of the disclosed embodiments to provide for an embossing method and system that utilizes ATA (Acoustic Transfer Assist) technology.

It is yet another aspect of the disclosed embodiments to provide for a dynamic embossing system with ATA technology in the context of a printing machine to create custom embossed and rendered documents and other materials and packaging.

The aforementioned aspects and other objectives and advantages can now be achieved as described herein. Embossing methods and systems are disclosed. In one example embodiment, a substrate (e.g., a sheet of paper or other material) can be delivered through a rendering device (e.g., a printer). An array of time-delayed pins can be driven into the substrate as the substrate travels through an in-line path provided by the rendering device to produce a latent embossed image composed of a combination of shapes depressed in the substrate. The substrate with the latent embossed image is then transferred to an ATA (Acoustic Transfer Assist) system, and the substrate is rendered with an embossed image based on the latent embossed image.

In some embodiments, the rendering device may be a printer and the substrate, a sheet of paper. In another example embodiment, the array of time-delayed pins can be electromechanically driven into the substrate. In yet another example embodiment, the array of time-delayed pins can be pneumatically driven into the substrate.

In another example embodiment, the array of time-delayed pins can be driven into the substrate via an embossing sub-system composed of a single head and a support platen that supports the substrate. In still another example embodiment, the array of time-delayed pints an be driven into the substrate via an embossing sub-system composed of a dual embossing head, wherein one embossing head generates the embossed image and another embossing head generates a reverse image.

In the dual embossing head example embodiment, the embossing device can be composed of two opposing matrix pin arrays. The array on one side of the substrate or media is driven with a positive displacement, while the opposing array is driven with a negative displacement. The use of ATA ensures that the image will transfer to the embossed area.

Benefits of such embodiments include the ability to emboss in either direction of the media, or even multiple directions of the media, or on one or both sides of the media. Additionally, since embossing takes place prior to transfer, there is no risk of damaging a printed image.

### BRIEF DESCRIPTION OF THE DRAWINGS

The accompanying figures, in which like reference numerals refer to identical or functionally-similar elements throughout the separate views and which are incorporated in and form a part of the specification, further illustrate the example embodiments and, together with the detailed description, serve to explain the principles of the disclosed embodiments.

FIG. 1 illustrates examples of prior art embossing plates, rolls, and embossed paper;

FIG. 2 illustrates a top view of a pin array embossing head, which can be implemented in accordance with a preferred example embodiment;

FIG. 3 illustrates a side view of a single head embossing system with a support platen, in accordance with an alternative example embodiment;

FIG. 4 illustrates a side view of a dual head embossing system, in accordance with another example embodiment;

FIG. 5 illustrates a block diagram of a print engine, in accordance with another example embodiment;

FIG. 6 illustrates sequence steps of a method for dynamic embossed image generation, in accordance with yet another example embodiment;

FIG. 7 illustrates a flow chart of operations depicting an embossing method, which can be implemented in accordance with an example embodiment;

FIG. 8 illustrates a schematic view of a computer system, in accordance with an embodiment; and

FIG. 9 illustrates a schematic view of a software system including a module, an operating system, and a user interface, in accordance with an embodiment.

### DETAILED DESCRIPTION

Reference will now be made in detail to exemplary embodiments of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Subject matter is described more fully hereinafter with reference to the accompanying drawings which form a part hereof and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and”, “or”, or “and/or” used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

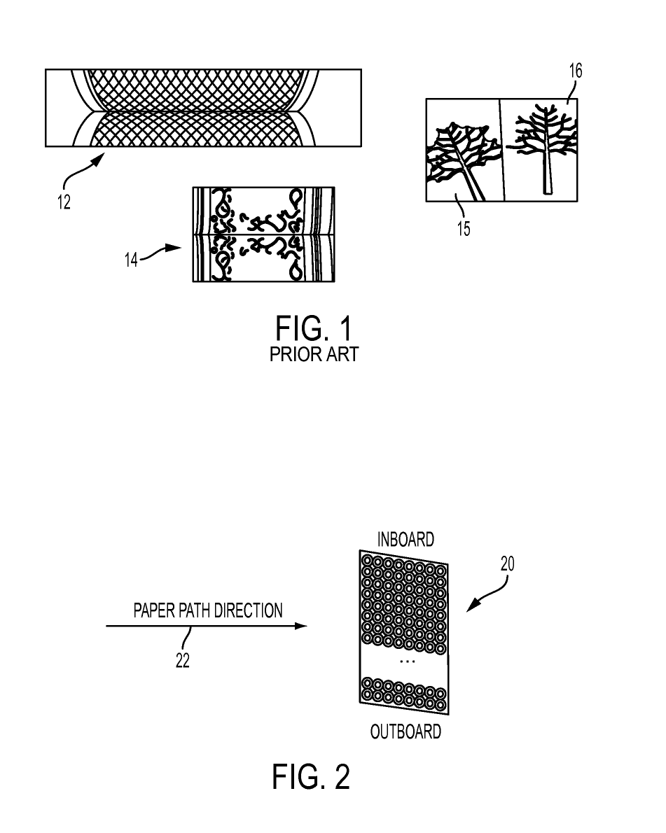

FIG. 2 illustrates a top view of a pin array embossing head 20, which can be implemented in accordance with a preferred example embodiment. An arrow 22 indicates the paper path direction. It can be appreciated that although the example embodiments depicted in FIGS. 2-6 illustrate the use of paper as a substrate to be embossed, such embodiments can be applied to the other substrate materials such as textiles, metals, foils, tiles, and so on. Inboard and outboard locations are also shown in FIG. 2 with respect to the example pin array embossing head. For illustrative purposes, however, reference is made herein primarily to paper as the substrate of interest. The pin array embossing head 20 depicted in FIG. 2 constitutes an array of time-delayed pins.

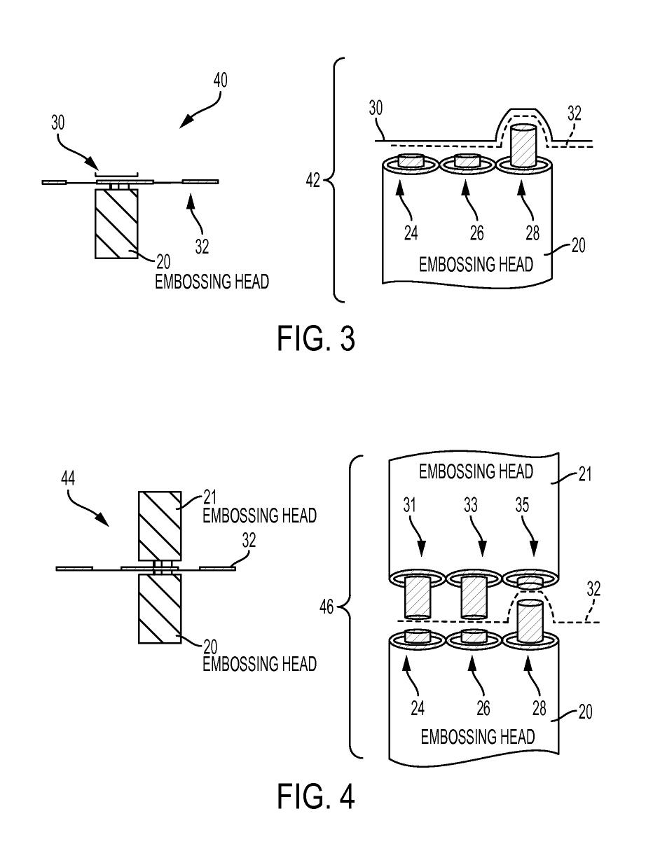

FIG. 3 illustrates a side view of a single head embossing system 40 with a support platen 30, in accordance with an alternative example embodiment. A close up view 42 of the pin array embossing head 20 is shown on the right hand side of FIG. 3 and left of the side view of system 40. A sheet of paper 32 (e.g., custom paper) is also shown in FIG. 3 in both the side view of system 40 and the close up view 42. The embossing head 20 includes a plurality of pins 24, 26, 28, which can form a part of the overall pin array configuration illustrated, for example, in FIG. 3.

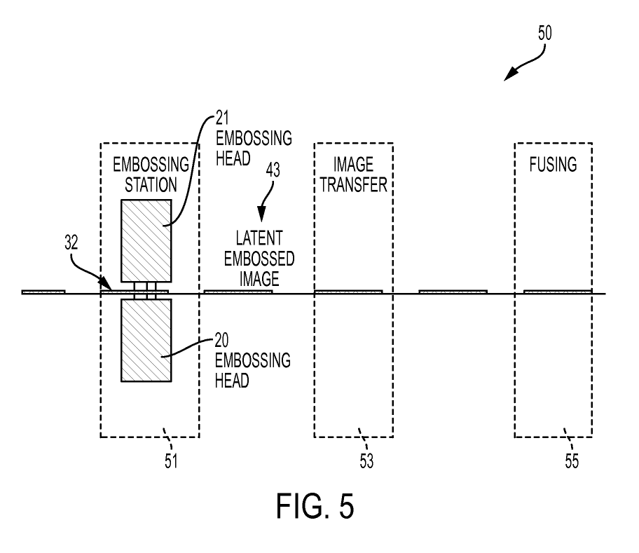

The array of time-delayed pins 24, 26, 28, etc., of the pin array embossing head 20 can be driven (e.g., electromechanically or pneumatically) into the custom paper 32 as the paper travels through, for example, the paper path 22 shown in FIG. 2 and in-line with the printing equipment or machine. The embossing system 30 shown in FIG. 3 can be located either upstream or downstream of the printing and fusing systems (which is shown in more detail in FIG. 5) and should be strategically placed to take advantage of ATA technology, as discussed in greater detail herein.

FIG. 4 illustrates a side view of a dual head embossing system 44, in accordance with another example embodiment. The dual head embossing system 44 includes the pin array embossing head 20 and another similar the pin array embossing head 21. The paper is 32 is shown in FIG. 4 with respect to both the pin array embossing heads 20 and 21. The pin array embossing heads 20 and 21 are configured with opposing matrix pin arrays. A close up view 46 of the dual head embossing system 44 is shown on the right hand side of FIG. 4. The pin array embossing head 21 includes pins 31, 33, 35, and so on, which form a part of an overall pin array configuration such as depicted in FIG. 2 and discussed herein.

The embossing systems 40 and 44 can be implemented as sub-systems or modules as part of an overall printing machine or system. The embossing system or subsystem 40, for example, can be composed of the single embossing head 20 with the support platen 30 as depicted in FIG. 3. The embossing system or subsystem 44 can include the dual embossing heads 20, 21 shown in FIG. 4 where one head generates the image while the other generates the reverse image.

After generating the dynamic embossed latent embossed image, the paper can then be transferred to an Acoustic Transfer Assist system (e.g., such as used in iGenF print engines) for printing. Optionally, the embossing subsystem can be disengaged to allow the sheets to pass through unembossed when not needed as it is expected that a reduction of print engine speed would be required to engage the embossing system.

FIG. 5 illustrates a block diagram of a print engine 50, in accordance with another example embodiment. The print engine 50 is composed of three stations or components. First, the print engine 50 can include an embossing station 51, which in some embodiments may include the dual head embossing system 44 composed of the embossing heads 20, 21. Second, the print engine 50 can include an ATA component or system 53 (i.e., image transfer) and finally a fusing component 55. Although the embossing station 51 is depicted in FIG. 5 with a dual embossing head sub-system, it can be appreciated that a single embossing head sub-system such as shown in FIG. 3 can be utilized in accordance with other embodiments.

After generating the dynamic embossed latent embossed image 43, the paper is then transferred to the Acoustic Transfer Assist component or system 53 for printing. Optionally, and as indicated previously, the embossing subsystem 51 can be disengaged to allow the sheets to pass through unembossed when not needed as it is expected that a reduction of print engine speed would be required to engage the embossing system. The ATA system 53 can be used to impart vibrations to the surface of the substrate/paper or other media to be embossed. ATA system 53 can provide for the efficient and complete transfer of a developed latent image from one surface to the embossed substrate despite the uneven surface created by the embossing operation. The ATA system 53 thus transfers an image to the substrate.

One example of an ATA system that can be adapted for use with an example embodiment is disclosed in U.S. Pat. No. 5,016,055 entitled “Method and Apparatus for using Vibratory Energy with Application of Transfer Field for Enhanced Transfer in Electrophotographic Imaging,” which is assigned to Xerox Corporation. The system disclosed in U.S. Pat. No. 5,016,055 describes an electrophotographic device that includes a flexible belt-type charge retentive member, beating a developed latent image and brings a sheet of paper or other transfer member into intimate contact with the charge retentive surface at a transfer station for electrostatic transfer of toner from the charge retentive surface to the sheet. At the transfer station, a resonator suitable for generating vibratory energy can be arranged in line contact with the back side of the charge retentive to uniformly apply vibratory energy to the charge retentive member surface at a position opposite the transfer coronode or peak transfer field or slightly upstream therefrom. Toner can be released from the electrostatic and mechanical forces adhering it to the charge retentive surface at the line contact position. U.S. Pat. No. 5,016,055 is incorporated herein by reference in its entirety.

Another example of an ATA system, which can be adapted for use with another example embodiment, is disclosed in U.S. Pat. No. 6,157,804 entitled, “Acoustic Transfer Assist Driver System,” which is also assigned to Xerox Corporation. U.S. Pat. No. 6,157,804 is incorporated herein by reference in its entirety. Other examples of ATA systems are those used in, for example, the “iGenF” print and rendering systems and products offered by Xerox Corporation.

Note that in some in some embodiments, if an ATA (of, for example, iGenF) is used, a customer or user may be able to create color registered embossing or debossing. The iGenF ATA, for example, employs acoustic transfer assist to enhance transfer of ink to paper with dimensional surface defects. An example embodiment can be configured with a controller to align the printed characters with the raised embossed features for color registered embossing.

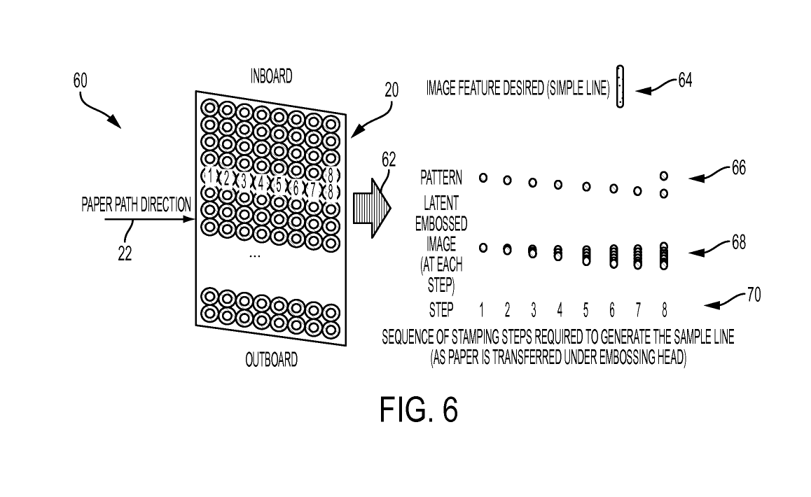

FIG. 6 illustrates sequence steps of a method 60 for dynamic embossed image generation, in accordance with yet another example embodiment. The paper path direction is shown in FIG. 6 with respect to arrow 22 and the example pin array embossing head 20. Arrow 62 indicates a sequence of stamping steps to be implemented to generate a sample line (as paper is transferred under the embossing head. The pattern 66 is shown in FIG. 6 with respect to the latent embossed image embossed at each step as shown by sequence 68 and the actual steps 70 (i.e., 1, 2, 3, 4, 5, 6, 7, 8). A desired image feature 64 (e.g., a simple line) is also shown in FIG. 6.

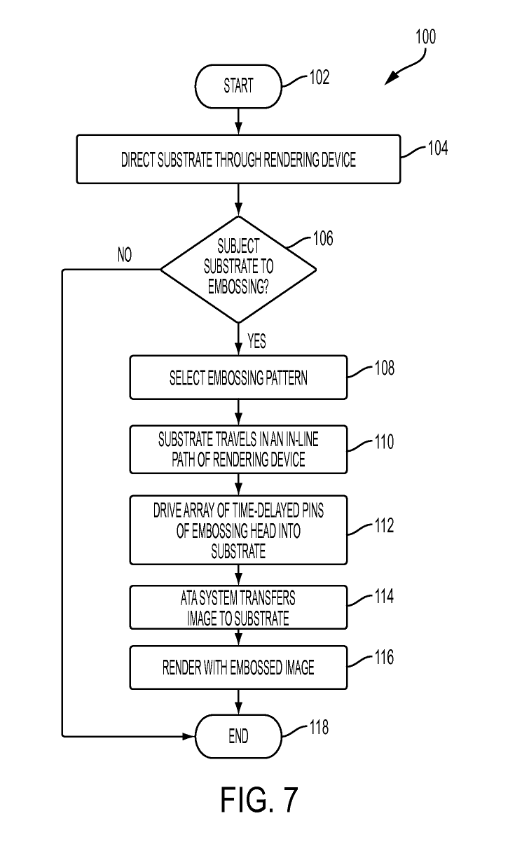

FIG. 7 illustrates a flow chart of operations depicting an embossing method 100, which can be implemented in accordance with an example embodiment. As indicated at block 102, the process begins. As shown next at block 104, a step or operation can be implemented to direct a substrate/media (e.g., paper, cloth, etc.) through the rendering device. As indicated next at decision block 106, a test can be performed to determine whether or not to proceed with the one or more of the disclosed embossing processes. Assuming the answer is “yes,” then as indicated at block 108, an embossing pattern can be selected. Thereafter, as illustrated at block 110, the substrate is directed to travel in an in-line path of the rendering device.

Then, as shown at block 112, an operation can be implemented to drive the array of time-delayed pins (of an embossing head, as discussed previously) to the substrate as the substrate travels through an in-line path of the rendering device to produce a latent embossed image composed of a combination of shapes depressed in the substrate by the array of time-delayed pins. Next, as illustrated at block 114, the ATA system transfers an image to the substrate. (e.g., see FIG. 5). The substrate can then be rendered with an embossed image based on the latent embossed image, as shown at block 116. The process can then terminate as indicated at block 118.

As can be appreciated by one skilled in the art, some example embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, some embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of an example embodiment may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on a user's computer, partly on a user's computer, as a stand-alone software package, partly on a user's computer and partly on a remote computer, or entirely on the remote computer. In some cases, the program code may execute on a processor associated with a rendering device such as a printer. In some scenarios, the remote computer may be connected to a user's computer through a local area network (LAN) or a wide area network (WAN), wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

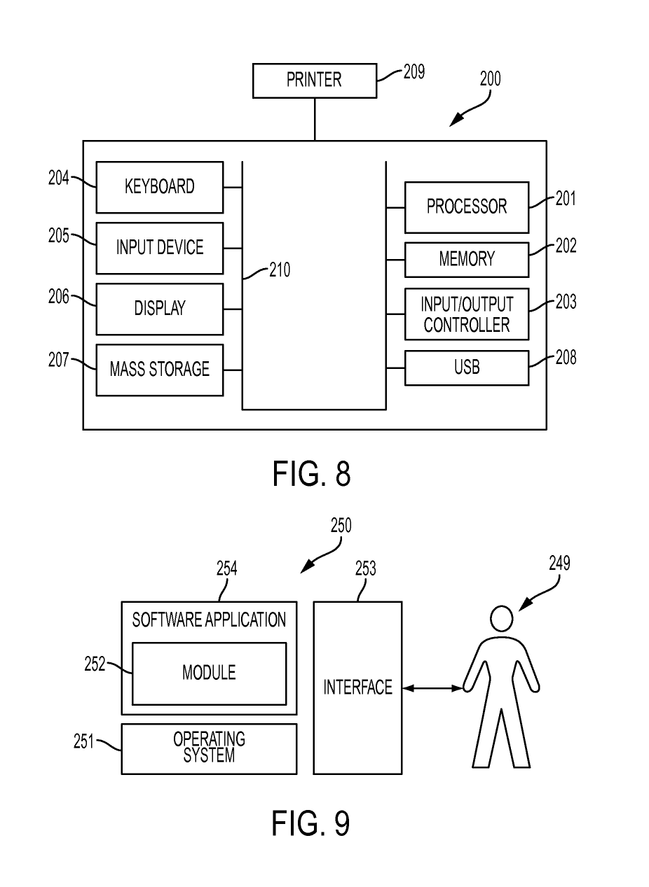

FIGS. 8-9 are shown only as exemplary diagrams of data-processing environments in which embodiments may be implemented. It should be appreciated that FIGS. 8-9 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 8, some embodiments may be implemented in the context of a data-processing system 200 that can include one or more processors such as processor 201, a memory 202, an input/output controller 203, a peripheral USB—Universal Serial Bus connection 208, a keyboard 204, an input device 205 (e.g., a pointing device, such as a mouse, track ball, pen device, etc.), a display 206, and in some cases, mass storage 207. In some embodiments, the system 200 can communicate with a rendering device, such as, for example, a printer 209, to render embossed objects as discussed herein.

As illustrated, the various components of data-processing system 200 can communicate electronically through a system bus 210 or similar architecture. The system bus 210 may be, for example, a subsystem that transfers data between, for example, computer components within data-processing system 200 or to and from other data-processing devices, components, computers, etc. Data-processing system 200 may be implemented as, for example, a server in a client-server based network (e.g., the Internet) or can be implemented in the context of a client and a server (i.e., where aspects are practiced on the client and the server). Data-processing system 200 may be, for example, a standalone desktop computer, a laptop computer, a Smartphone, a pad computing device, and so on.

FIG. 9 illustrates a computer software system 250 for directing the operation of the data-processing system 200 depicted in FIG. 8. Software application 254, stored for example in memory 202, generally includes a kernel or operating system 251 and a shell or interface 253. One or more application programs, such as software application 254, may be “loaded” (i.e., transferred from, for example, mass storage 207 or other memory location into the memory 201) for execution by the data-processing system 200. The data-processing system 200 can receive user commands and data through the interface 253; these inputs may then be acted upon by the data-processing system 200 in accordance with instructions from operating system 251 and/or software application 254. The interface 253 in some embodiments can serve to display results, whereupon a user 249 may supply additional inputs or terminate a session. The software application 254 can include a module(s) 252 that can, for example, implement instructions or operations such as those described in FIGS. 6-7 and described elsewhere herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 8-9 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

Based on the foregoing, it can be appreciated that a number of embodiments, preferred and alternative, are disclosed. For example, in a preferred example embodiment, an embossing method can be implemented which includes steps or operations such as delivering a substrate through a rendering device and driving an array of time-delayed pins into the substrate as the substrate travels through an in-line path of the rendering device to produce a latent embossed image composed of a combination of shapes depressed in the substrate by the array of time-delayed pins.

In another example embodiment, steps or operations can be provided for transferring the substrate with the latent embossed image to an acoustic transfer assist system and rendering the substrate with an embossed image based on the latent embossed image. In some example embodiments, the rendering device may be a printer and the substrate can be a sheet of paper or other media that the printer is capable of rendering.

In another example embodiment, the step or operation of driving the array of time-delayed pins into the substrate can further involve electromechanically driving the array of time-delayed pins into the substrate. In yet another example embodiment, the step or operation of driving the array of time-delayed pins into the substrate can further include a step or operation of pneumatically driving the array of time-delayed pins into the substrate.

In another example embodiment, the step or operation of driving the array of time-delayed pins into the substrate can further include a step or operation of driving the array of time-delayed pins into the substrate via an embossing sub-system that includes one or more embossing heads and a support platen for supporting the substrate.

In still another embodiment, the embossing head(s) can be configured as a dual embossing head composed of a first embossing head and second and opposing embossing head that facilitates embossing of a reverse image of the embossed image with respect to the substrate.

In yet another embodiment, an embossing system can be implemented, which includes, for example, a rendering device, wherein a substrate is delivered through the rendering device; and one or more embossing heads electromechanically connected to the rendering device, the embossing head(s) having an array of time-delayed pins, wherein the array of time-delayed pins is driven into the substrate as the substrate travels through an in-line path of the rendering device to produce a latent embossed image composed of a combination of shapes depressed in the substrate by the array of time-delayed pins.

In another example embodiment, the aforementioned system can be configured to include an acoustic transfer assist system, wherein the substrate is transferred to the acoustic transfer assist system with the latent embossed image, and the rendering device subsequently renders the substrate with an embossed image based on the latent embossed image.

In some example system embodiments, the rendering device can be a printer and the substrate can be a sheet of paper. In another example system embodiment, the array of time time-delayed pins can be driven electromechanically into the substrate or pneumatically into the substrate. In another example system embodiment, the array of time-delayed pins can be driven into the substrate via an embossing sub-system including the embossing head(s) and a support platen for supporting the substrate. In yet another example system embodiment, the embossing head(s) can be configured as a dual embossing head composed of a first embossing head and second and opposing embossing head that facilitates embossing of a reverse image of the embossed image with respect to the substrate.

In another example embodiment, an embossing system can be implemented, which includes one or more processors (e.g., processor 201) and a computer-usable medium embodying computer program code. The computer-usable medium is capable of communicating with the processor(s), and the computer program code can include instructions executable by the processor(s) and configured for: delivering a substrate through a rendering device and driving an array of time-delayed pins into the substrate as the substrate travels through an in-line path of the rendering device to produce a latent embossed image composed of a combination of shapes depressed in the substrate by the array of time-delayed pins.

In some example system embodiments, the aforementioned instructions can be further configured for transferring the substrate with the latent embossed image to an acoustic transfer assist system and rendering the substrate with an embossed image based on the latent embossed image.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. An embossing method, comprising:
delivering a substrate through a rendering device; and
driving an array of time-delayed pins into said substrate as said substrate travels through an in-line path of said rendering device to produce a latent embossed image composed of a combination of shapes depressed in said substrate by said array of time-delayed pins.

2. The method of claim 1 further comprising rendering:
transferring said substrate with said latent embossed image to an acoustic transfer assist system; and
rendering said substrate with an embossed image based on said latent embossed image.

3. The method of claim 1 wherein said rendering device comprises a printer and said substrate comprises a sheet of paper.

4. The method of claim 1 wherein driving said array of time-delayed pins into said substrate further comprises electromechanically driving said array of time-delayed pins into said substrate.

5. The method of claim 1 wherein driving said array of time-delayed pins into said substrate further comprises pneumatically driving said array of time-delayed pins into said substrate.

6. The method of claim 2 wherein driving said array of time-delayed pins into said substrate further comprises driving said array of time-delayed pins into said substrate via an embossing sub-system comprising at least one embossing head and a support platen for supporting said substrate.

7. The method of claim 6 wherein said at least one embossing head comprises a dual embossing head composed of a first embossing head and second and opposing embossing head that facilitates embossing of a reverse image of said embossed image with respect to said substrate.

8. An embossing system, comprising:
a rendering device, wherein a substrate is delivered through said rendering device; and
at least one embossing head electromechanically connected to said rendering device, said at least one embossing head having an array of time-delayed pins, wherein said array of time-delayed pins is driven into said substrate as said substrate travels through an in-line path of said rendering device to produce a latent embossed image composed of a combination of shapes depressed in said substrate by said array of time-delayed pins.

9. The system of claim 8, further comprising an acoustic transfer assist system, wherein:
said substrate is transferred to said acoustic transfer assist system with said latent embossed image, and
said rendering device subsequently renders said substrate with an embossed image based on said latent embossed image.

10. The system of claim 8 wherein said rendering device comprises a printer and said substrate comprises a sheet of paper.

11. The system of claim 8 wherein said array of time-delayed pins is driven electromechanically into said substrate.

12. The system, of claim 8 wherein said array of time-delayed pins is driven pneumatically into said substrate.

13. The system of claim 9 wherein said array of time-delayed pins is driven into said substrate via an embossing sub-system comprising said at least one embossing head and a support platen for supporting said substrate.

14. The system of claim 13 wherein said at least one embossing head comprises a dual embossing head composed of a first embossing head and second and opposing embossing head that facilitates embossing of a reverse image of said embossed image with respect to said substrate.

15. An embossing system, comprising:
at least one processor;
a computer-usable medium embodying computer program code, said computer-usable medium capable of communicating with said at least one processor, said computer program code comprising instructions executable by said at least one processor and configured for:
delivering a substrate through a rendering device; and
driving an array of time-delayed pins into said substrate as said substrate travels through an in-line path of said rendering device to produce a latent embossed image composed of a combination of shapes depressed in said substrate by said array of time-delayed pins.

16. The system of claim 15, wherein said instructions are further configured for:
transferring said substrate with said latent embossed image to an acoustic transfer assist system; and
rendering said substrate with an embossed image based on said latent embossed image.

17. The system of claim 15 wherein said rendering device comprises a printer and said substrate comprises a sheet of paper.

18. The system of 15 wherein said instructions for driving said array of time-delayed pins into said substrate further comprises instructions for electromechanically or pneumatically driving said array of time-delayed pins into said substrate.

19. The system of claim 16 wherein driving said array of time-delayed pins into said substrate further comprises driving said array of time-delayed pins into said substrate via an embossing sub-system comprising at least one embossing head and a support platen for supporting said substrate.

20. The system of claim 19 wherein said at least one embossing head comprises a dual embossing head composed of a first embossing head and second and opposing embossing head that facilitates embossing of a reverse image of said embossed image with respect to said substrate.
